(19) United States
(12) Patent Application Publication
(10) Pub. No.: US 2025/0232908 A1
(43) Pub. Date: Jul. 17, 2025

(54) ELECTRICAL TRANSFORMER WITH RESONANT PRIMARY AND INDUCTIVE SECONDARY AND ITS MANUFACTURING METHOD

(71) Applicant: RESON ENERGY LTDA, Araguari-Mg (BR)

(72) Inventors: Lázaro DOS REIS MAGALHÃES, Araguari-Mg (BR); Diego MALDINI SOUZA DE OLIVEIRA, Araguari-Mg (BR)

(21) Appl. No.: 18/698,259

(22) PCT Filed: Dec. 1, 2021
(86) PCT No.: PCT/BR2021/050531

§ 371 Date: Apr. 3, 2024

(30) Foreign Application Priority Data
Oct. 8, 2021 (BR) BR 1020210202378

(51) Int. Cl. H01F 27/28; H01F 27/24; H01F 41/069

(52) U.S. Cl. CPC H01F 27/28; H01F 27/24; H01F 41/069

(57) ABSTRACT

An electric transformer with a resonant primary and an inductive secondary includes a magnetic core, a primary winding having a first polarity and a secondary winding comprising a bifilar winding coupled in parallel to the primary winding and having an opposite polarity to the first polarity, the bifilar winding comprising a first winding and a second winding interconnected in series at a central derivation point, to which a first end of the capacitor is connected, the second end of the capacitor being connected to the input of the primary winding, wherein the first winding and the second winding each comprises a number of turns that corresponds to 40% of the number of turns of the primary winding; and wherein the bifilar winding is arranged in the same leg of the magnetic core of the primary winding. And a method for manufacturing the electric transformer.

### FIELD OF INVENTION

This invention refers to the field of electrical engineering. Meaning, this invention refers to an electric transformer capable of converting electric energy with high efficiency.

### INVENTION BACKGROUND

Electric transformers are necessary to match the input voltage that feeds the primary windings to a desired output voltage in the secondary windings by varying the magnetic flux between the primary and secondary windings. This is mainly due to the number of coils, the distance between the windings, the type of core used and the e wires diameter in each winding.

However, there are a few factors that are also taken into account when designing a transformer, such as losses in the windings due to the Joule effect, by hysteresis, eddy currents, magnetic flux dispersion and the saturation effect on the magnetization waveform. Such factors contribute negatively to the achievement of the desired output voltage of the transformer, and they reduce its efficiency.

Some solutions that have already been made public and they show techniques for mitigating such effects on the transformer operation and thus, increase the power efficiency. Such documents are briefly described and are published below.

The patent document GB530457, filed on Jun. 23, 1939, by THE TOKYO ELECTRIC COMPANY, discloses a high-reactance transformer comprising a primary and a secondary, and an auxiliary winding in two opposite parts 5, 6 on opposite sides of the magnetic shunt 2 and connected in a closed circuit to a capacitor 7 for power factor correction. However, this document does not use a bifilar winding with its polarity opposed to the primary winding and arranged on the same leg as the primary winding in the core. This document differs from this present invention in that it discloses a core having a magnetic shunt, where the auxiliary windings are arranged on different sides of the magnetic shunt.

Another acknowledged technique is described in document WO 02/095922 A1, filed on May 17, 2002, by COMAIR ROTRON INC., in which a first auxiliary winding AI is coupled in series to a capacitor C and a second auxiliary winding is alternatively connected in parallel to the first auxiliary winding. When the second auxiliary winding is not connected in parallel, it is connected to one end of the AI auxiliary winding but its other end is not connected to anything (open). In this way, the setup of that retroactivity allows the engine to work with higher torques/loads. The accomplishment of this invention differs from this document in that the primary and secondary windings are connected in parallel and, when both are taken into account to attain the proposed purpose, one of these windings is arranged in an open circuit.

The transformers currently known in the market only convert electric energy without providing any gains and with a small percent loss of energy efficiency. This invention, in turn, has the advantage of providing the same energy conversion of the devices on the market, but instead of a loss in conversion, the purpose of this invention provides an energy increase. Besides its cost-effectiveness, the proposed design also provides greater voltage and current stability at the transformer's output terminals.

### INVENTION SUMMARY

One purpose of the invention is to provide an electric transformer with resonant primary and inductive secondary, capable not only of performing the proposed transformation, but also of attenuating losses by including a resonant circuit on the primary side, interacting with the main primary winding and converts the input circuit reactive power into useful power for the system.

Another purpose of this invention is to provide an output signal in the secondary terminal with a high power factor, thus improving the power efficiency of the transformer.

This invention meets the proposed requirements using an electric transformer with a resonant primary winding and an inductive secondary winding, comprising a magnetic core, a primary winding with first polarity and a secondary winding comprising:
a bifilar winding coupled in parallel and with polarity opposite to the first polarity, the bifilar winding being comprising the first winding and the second winding connected in series with each other, through a central shunt point, to which the capacitor first end is connected, and the capacitor second end being connected to the primary winding input, where the first winding and the second winding each comprise a number of coils corresponding to 40% of the primary winding coils, and where the bifilar winding is arranged on the same leg as the magnetic core of the primary winding.

According to one embodiment of this invention, the transformation ratio between the primary winding and the secondary winding is 1:1, or another set according to the desired output voltage.

According to one embodiment of this invention, the winding wires diameter is the same as that of the primary winding as well as that of the secondary winding.

This invention also discloses a manufacturing method of an electric transformer comprising a magnetic core, a primary winding with first polarity and a secondary winding, comprising:
add a bifilar winding coupled in parallel and in the opposite direction to the primary winding, the bifilar winding comprising the first winding and the second winding connected in series to each other, through a break out point, to which the first end of the capacitor is connected and the second end of the capacitor is connected to the primary winding input, where the first winding and the second winding each comprise a number of coils corresponding to 40% of the primary winding coils;
measure electric parameters such as reactive power, active power and power factor in the transformer secondary winding; and calculate a capacitor value taking into account measured electrical parameters, so that the capacitor is in resonance with the bifilar winding and corrects the power factor to a set value.

### BRIEF DESCRIPTION OF THE FIGURES

FIG. 1 shows the circuit of an exemplary conventional single-phase transformer with a magnetic core, a primary winding and a secondary winding.

FIG. 2 shows the circuit implementing the single-phase transformer, according to the achievement of this invention.

FIG. 3 shows the implementation circuit of the exemplary three-phase transformer according to the achievement of this invention.

### DETAILED INVENTION DESCRIPTION

The capacity of the new transformer topology uses the power factor, considered a critical point in all inductive circuits, and converts reactive energy into useful energy, improving the efficiency and quality of the transformer output. In the process of the new electric transformer topology of this invention, the conventional manufacturing and installation process of any transformer is already well established in electrical engineering.

The distinctive features of the transformer in this invention are applicable to single-phase, two-phase or three-phase transformers widely known in the art, with a frequency of 50/60 Hz in the residential, commercial and industrial segments.

In addition to this, the inventive design of the electric transformer in this invention also applies to a wide range of high-frequency electric equipment for transformation and conversion, including converters, inverters and switching sources. However, for high-frequency applications, a ferrite core or another suitable material is used.

FIG. 1 shows a conventional single-phase electric transformer circuit, comprising a magnetic core M, a primary winding PI and a secondary winding SI. In the transformers known in the art, the primary winding PI and the secondary winding SI are calculated in the conventional form according to the desired working power and voltage.

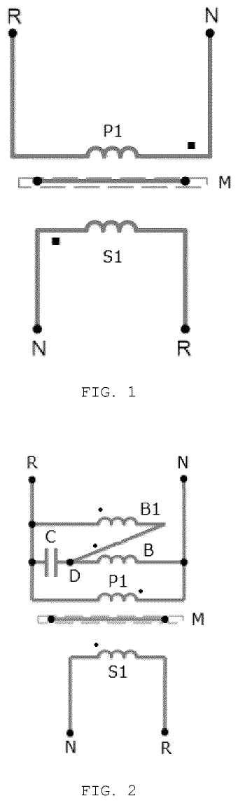

The electric transformer of this invention is characterized by adding two more windings B, BI connected in series to each other on the same leg of the magnetic core M of the primary winding, the windings B, BI being connected in parallel to the primary winding, and being connected at a tap D with one or more capacitors C, properly adjusted according to the resonance and the power factor correction, as seen in FIG. 2.

The transformer in this invention comprises a magnetic core M, a primary winding PI and a secondary winding SI. The transformation ratio ranges according to the desired output voltage. The primary and secondary windings serve as a reference for calculating the two additional windings B, BI. The arrangement and connection of the parallel windings is the main feature of the referred invention process.

The core M is made of rolled iron for operation at low frequencies or ferrite for operation at high frequencies. On top of that, the core M may comprise the EI, UI, C or toroidal formats.

According to the realization of this invention, an electric transformer is provided with a resonant primary winding and an inductive secondary winding, comprising a magnetic core M, a primary winding P1 with first polarity and a secondary winding S1, and the transformer comprises:
a bifilar winding B, BI coupled in parallel to the primary winding PI and with polarity opposite to the first polarity, the bifilar winding being comprised of the first winding B and a second winding BI connected in series to each other, through a central tap D, to which the first end of a capacitor C is connected, and the second end of the capacitor C being connected to the primary winding P1 input,
where the first winding B and the second winding BI each, comprise a number of coils corresponding to 40% of the primary winding coils; and
where the bifilar winding is arranged on the same leg of the magnetic core M as the primary winding P1.

The core M is made of cast iron for operation at low mains frequencies, but it can be made of ferrite for operation at higher frequencies. The B, BI windings are wound on one leg of the core M, immediately after the end of the PI primary winding and share the same insulation layer, without, however, being isolated from the PI primary winding, so that their magnetic fields interact with each other. In turn, the primary winding PI and the windings B, BI are insulated from the secondary winding SI, as conventionally established.

The diameter of the B, BI windings wires is the same as that of the primary winding, as well as the secondary winding. However, the secondary winding diameter can vary according to the desired output voltage.

The two windings B, BI are connected in series to form a bifilar coil. The ends of the bifilar coil B, BI are connected in parallel to the ends of the primary coil PI, so that the magnetic orientation opposes the magnetic flux of the primary winding PI. The central tap D of this bifilar coil serves as the connection point for one end of the capacitor C, which also connects to the input end of the primary winding PI, as shown in FIG. 2.

The opposite bifilar coil is capable of generating a magnetic saturation in the core of up to 70%, directly proportional to the number of coils of the parallel windings B, BI. The resulting magnetic fields in the magnetic core M are inversely proportional to the reactance difference in between the primary coil PI and the bifilar coil made up of windings B, BI. The magnetic saturation resultancy of the iron core M creates a power factor close to 1 (one) as a result of the interaction of the opposing magnetic fields in the primary and bifilar windings.

This invention also discloses a method for manufacturing an electric transformer with a resonant primary winding and an inductive secondary winding comprising a magnetic core M, a primary winding PI with first polarity and a secondary winding SI comprising:
add a bifilar winding coupled in parallel to the primary winding and in the opposite direction to the first polarity; the bifilar winding consists of the first winding B and the second winding BI connected in series to each other through a central tap D, to which the first end of a capacitor C is connected and the second end of the capacitor C is connected to the primary winding P1 input,
where the first winding B and the second winding BI each, comprise a number of coils corresponding to 40% of the primary winding coils; and
where the bifilar winding is arranged on the same leg of the magnetic core M as the primary winding P1;
measure, using a power analyzer, electric parameters such as reactive power, active power and power factor in the transformer secondary winding; and
calculate a value for capacitor C considering electric parameters measured so that the capacitor is in resonance with the bifilar winding B, BI and correct the power factor to the value of 1 (one).

Adjusting capacitor C requires the use of an oscilloscope and a power analyzer capable of measuring and monitoring several parameters, namely: reactive power and the system's power factor, as well as the waveform for calculating active power. For the topology calculations and adjustments, the analyzer should be connected to the transformer's PI primary winding to measure the power factor, reactive power and the signal in the system supplying the active power. The appropriate value for capacitor C is selected after reading the parameters and making calculations for power factor correction, in order to increase the power factor in the primary winding PI, as well as generating a reactive power in the winding BI in series with capacitor C. The calculations for determining the reactive power and adjusting the power factor in the system are carried out conventionally, according to the current legislation. Formula 1 below allows the power factor to be achieved by taking the active and reactive powers into account:

$$FP = \frac{kWh}{\sqrt{{kWh}^{2} + k var {h}^{2}}}$$

Whereas:
PF—power factor
kW—active power
kvar—reactive power

By making the necessary adjustments to the value of capacitor C, the system keeps a LC resonance through winding B, and the interaction of the magnetic fluxes of the two windings B, BI through capacitor C is able to maintain the partial saturation of the core at the cost of the circuit reactive power. The initial power factor is corrected, the resonance operates at the expense of a very low value of active power and keeps the saturation in the opposite windings. Part of such reactive resonance energy is converted by the BI winding into a magnetic field in the core M, and the magnetization phase of the BI winding coincides with the PI primary winding. The practical result of this new process in the transformer topology is a power factor of 1 (one) in the SI secondary output phase.

The new form of resonant primary magnetization used to complete the transformer structure provides an input×output gain that can range from 51% to 62%. However, such gain is variable and depends on the control performed by the reactive capacitors C. In conventional transformers, instead of gain, there is usually a loss due to the magnetic iteration of the primary and secondary windings.

Therefore, the use of capacitor C is related to the correction of the power factor, i.e., the correction of the reactive power generated by the bifilar coil resonance.

The benefits achieved by this invention are many, since the transformer is capable of converting reactive power into useful power and thus increase the power factor. Such benefits include the following:
energy cost reduction;
reduction in the Joule effect associated with heat loss, as the equipment becomes more efficient;
increased service life of the installation and the equipment connected to the transformer; and
increased installation power efficiency.

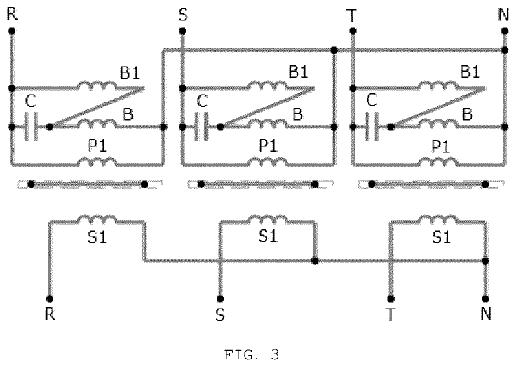

FIG. 3 shows a second exemplary application of the inventive concept of this invention, in a three-phase transformer with a star connection.

It will be easily understood by those skilled in the art that changes can be made to the invention without departing from the concepts set out in the preceding description. Such modifications should be held to be included within the scope of the invention. Consequently, the particular realizations outlined in detail above are only illustrative and not limiting, as to the scope of the invention, to which the full extent of the appended claims and any and all equivalents thereof should be given.

1. An electric transformer with resonant primary windings and inductive secondary windings comprising a magnetic core, a primary winding with a first polarity and a secondary winding, the electric transformer comprising:
a bifilar winding coupled in parallel to the primary winding and with polarity opposite to the first polarity, the bifilar winding being comprised of the first winding and the second winding connected in series to each other through a central tap, to which the first end of a capacitor is connected, and the second end of the capacitor being connected to the input of the primary winding,
wherein the first winding and the second winding each comprise a number of coils corresponding to 40% of the coils of the primary winding; and
wherein the bifilar winding is arranged on the same leg of the magnetic core as the primary winding.

2. The electric transformer, according to claim 1, wherein the transformation ratio between the primary winding and the secondary winding is 1:1 or another set according to the desired output voltage.

3. The electric transformer according to claim 1, wherein the core is made of cast iron or ferrite.

4. The electric transformer according to claim 1, wherein the core comprises the EI, UI, C or toroidal shapes.

5. The electric transformer according to claim 1, wherein the diameter of the windings' wires is the same as that of the primary winding, as well as that of the secondary winding.

6. A manufacturing method of an electric transformer with resonant primary winding and inductive secondary winding comprising a magnetic core (M), wherein a primary winding with first polarity and a secondary winding, the method comprising:
adding a bifilar winding coupled in parallel to the primary winding and in the opposite direction to the first polarity, the bifilar winding being comprised of the first winding and the second winding connected in series to each other through a central tap, to which the first end of a capacitor (C) is connected and the second end of the capacitor (C) is connected to the primary winding input,
wherein the first winding and the second winding each comprise a number of coils corresponding to 40% of the coils of the primary winding; and
wherein the bifilar winding is arranged on the same leg of the magnetic core as the primary winding; measure using a power analyzer, electric parameters such as reactive power, active power and power factor in the transformer secondary winding; and
calculate a value for capacitor C considering electric parameters measured so that the capacitor is in resonance with the bifilar winding and correct the power factor to the value of 1.
